(19) United States
(12) Patent Application Publication
(10) Pub. No.: US 2012/0241228 A1
(43) Pub. Date: Sep. 27, 2012

(54) LOW PROFILE WEIGHING SCALE

(76) Inventor: Robert Prus, Houston, TX (US)

(21) Appl. No.: 13/072,115

(22) Filed: Mar. 25, 2011

(51) Int. Cl. G01G 21/28

(52) U.S. Cl. 177/244

(57) ABSTRACT

A compact, pivotally foldable weighing scale for weighing heavy objects such as luggage. The scale may comprise a base comprising four structural members coupled together to describe a rectangle, and a subframe pivotally mounted to the base. The subframe supports a weight receiving platform, a weight sensor, and a display for displaying sensed or measured weight. The subframe may be pivotally mounted to the base at one end of the latter. The weight sensor may comprise a collapsible and expansible pneumatic or hydraulic piston. The display may comprise an analog gauge or alternatively may be an electronic display adapted to display English and metric units of weight. Further, the scale could have a built-in speaker and memory capabilities. The scale may be less than twelve inches in height and five inches in each of width and height. The scale may be provided commercially with an enclosure such as a flexible pouch or generally rigid box.

### FIELD OF THE INVENTION

The present invention relates to scales, and more particularly to a low profile scale for weighing objects without necessitating that the user entire lift the object off the ground.

### BACKGROUND OF THE INVENTION

When weighing objects that may be near or even beyond the ability of a person to lift those objects, it is desirable to provide a scale which can fold to a very compact low profile. An example is seen with luggage which is subject to additional financial charges or even restrictions if brought aboard an aircraft. Passengers frequently weigh their luggage to assure compliance with these charges or restrictions. As one of the current thresholds or limitations upon weight is on the order of seventy pounds, it is at a minimum difficult to hoist such a weight more than nominally above a floor or ground surface. For some people, such a burden may be beyond their abilities.

Scales which are intended for consumer use such as so-called bathroom scales have fairly low profiles. However, the readout or display of such scales, which may be easily read by a person weighing himself or herself, may be obscured when a person holds an object such as luggage. Typically, the luggage is held immediately in front of the body, thereby obscuring the readout by interposing the luggage into what would otherwise be a direct line of sight to the readout.

It would be possible to place one end of the luggage on a scale, so that luggage can be weighed without requiring a person to lift the luggage and stand on the scale. However, consumer type scales are typically constructed so that the weight must be imposed on the center of the weight platform. It is not feasible to weigh one end of a piece of luggage on a scale since with one end remaining on the floor; it is usually not possible to impose the weight of the other end on the horizontal surface of the weight platform of a consumer type scale.

There exists a need for a scale which is of low profile and yet can accept objects such as luggage

### SUMMARY OF THE INVENTION

The present invention provides a scale which has a low profile, which enables an object to be lowered over a weighing platform adapted to accommodate the object being lowered over only one side of the scale. Weighing is accomplished by tilting the luggage, placing the scales underneath and tilting back to the upright when the weight of the luggage rests entirely on the scale. The user is not obliged to assume the burden of lifting the entire load off the ground or floor and then lower the load over the center of the scale. Also, the readout or display projects well away from the load platform, and thus is not obscured.

The scale may comprise an uncomplicated pivotally folding frame which supports a load platform and a pneumatic or hydraulic weight measuring element. This weight measuring element may comprise a compressible and expansible piston and a pneumatic or hydraulic device for converting pressure to a suitable weight readout or be made of electronic sensors entirely.

It is an object of the invention to provide a scale which is particularly suited for accommodating objects which are just heavy enough so as not to be easily lifted from the ground or floor and which are not easily maneuvered into place over the center of the weight platform of a scale.

Another object of the invention is to provide a scale having a readout or display which is readily readable from above, even with a load in place on the weight platform.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a perspective view of a weighing scale according to at least one aspect of the invention.

FIG. 2 is an environmental perspective view of the weighing scale of FIG. 1, showing luggage loaded thereon.

FIG. 3 is a plan detail view of an alternative form of a pressure gauge that may be used with a weighing scale such as the weighing scale of FIG. 1.

FIG. 4 is a diagrammatic side view of a weighing scale such as the weighing scale of FIG. 1, displayed beside a rigid container therefore.

FIG. 5 is a diagrammatic side view of a weighing scale such as the weighing scale of FIG. 1, displayed beside a flexible pouch for enclosing the weighing scale.

### DETAILED DESCRIPTION

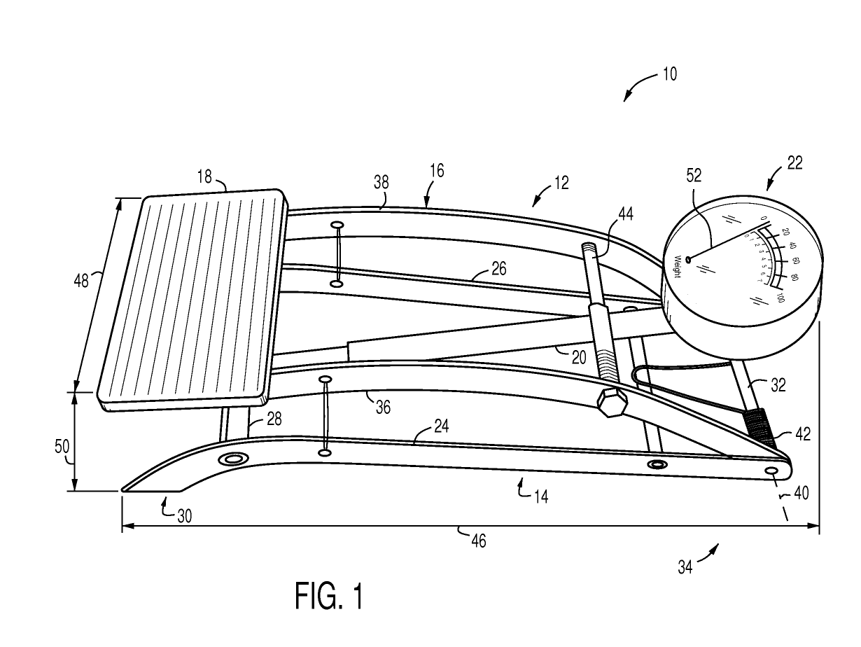

Referring first to FIG. 1, according to at least one aspect of the invention, there is shown a weighing scale 10 which comprises a structural frame 12 which in turn comprises a base 14 disposed to support the weighing scale 10 on a horizontal environmental surface such as a floor or the ground (neither shown), and a subframe 16 coupled to the base. A weight receiving platform 18 is disposed at one end of the structural frame 12 and is mounted on the subframe 16. The subframe 16 is disposed to couple the weight receiving platform 18 to the base 14.

A sensor is disposed to measure weight imposed on the weight receiving platform 18. This sensor may operate pneumatically or hydraulically, for example comprising a compressible and expansible piston and cylinder assembly 20 which imposes force on a gas such as air entrapped therein when a weight is imposed on the weight receiving platform 18. A display such as the face of an analog gauge 22 disposed to display measured weight imposed on the weight receiving platform 18 is operably connected to the piston 20.

The frame 12 is collapsible or partially foldable, responsive to weight imposed on the weight receiving platform 18. This movement enables the piston and cylinder assembly to compress so as to provide an operating pneumatic or hydraulic signal to the analog gauge 22. As the frame collapses or partially folds, the subframe 16 assumes a first location when the weighing scale 10 is in an unloaded condition, and moves pivotally relative to the base 14 to a second location when weight is imposed on the weight receiving platform 18.

This is better understood when the relationship of the subframe 16 to the base 14 is further detailed. The base may be configured in at least one view as a rectangle defined by a first side channel 24, an opposed and generally parallel similar second side channel 26, a proximal cross bar 28 spanning and connecting the first side channel 24 to the second side channel 26 at that end 30 of the base 14 as seen at the left in FIG. 1, and an axle member 32 spanning and connecting the first side channel 24 to the second side channel 26 at an opposed end 34 of the base 14. In the exemplary implementation of the invention of FIG. 1, the base 14 is seen to describe a rectangle.

The subframe 16 may have similar construction, comprising a first side rail 36, and a second side rail 38 which is spaced apart from and generally parallel to the first side rail 36. The weight receiving platform 18 may include a sturdy structural element (not separately shown), thereby serving as a laterally disposed member, which spans and is coupled to the first side rail 36 and the second side rail 38. Although not fixed immovably to the subframe 16, the axle member 32, which is common to both the base 14 and also the subframe 16, completes the rectangle which includes the first side rail 36, the second side rail 38, and the weight receiving platform 18. The subframe 16 may move pivotally relative to the base 14 about an axis 40 of the axle member 32.

Hence, the two rectangular members, i.e., the base 14 and the subframe 16, can pivot in clamshell fashion relative to one another.

A spring 42 may be disposed to act on the subframe 16 so as to urge the weight receiving platform 18 upwardly as seen in FIG. 1, away from that end 30 of the base 14 which is proximate the weight receiving platform 18. This assures that the piston and cylinder assembly 20 will always function as intended when a load is imposed on the weight receiving platform 18, i.e., responding by compressing air or liquid to provide a new signal to the analog gauge 22.

It should be noted at this point that the drawing figures depict their subject matter in orientations of normal use, which could obviously change with changes in orientation of the weighing scale 10. Therefore, orientational terms such as “upwardly” must be understood to provide semantic basis for purposes of description, and do not limit the invention or its component parts in any particular way.

The piston and cylinder assembly 20 may be supported by connection at the weight receiving platform 18 and by connection to a cross member 44 which is a part of the subframe 16. The mechanical nature of this connection will accommodate folding or collapse of the structural frame 12. Thus it is seen that the piston and cylinder assembly 20 may be fixed at one end to the weight receiving platform 18 and also at a point along its length to the subframe 16.

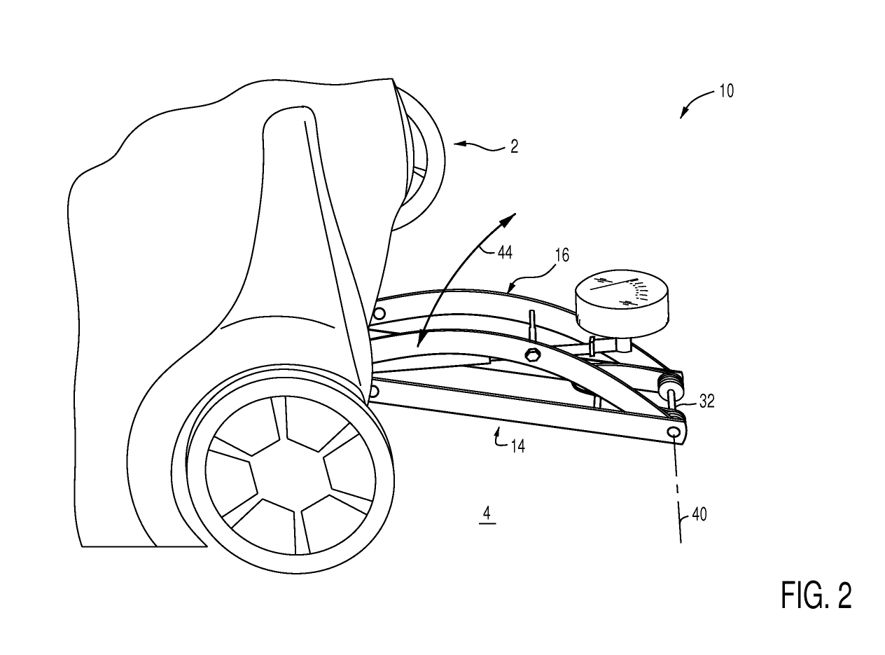

FIG. 2 shows a representative use of the weighing scale 10, wherein an article of traveling luggage 2 has been placed onto the weight receiving platform 18, the latter being concealed from view in FIG. 2. With the base 14 remaining stationary on an environmental surface such as a floor 4, the subframe 16 may swing about the axis 40 of the axle member 32, as indicated by the arrow 44. The arrow 44 is exaggerated for clarity of understanding of the motion of the subframe 16. The total travel of the subframe 16 is actually only a small fraction of the length of the arrow 44.

An advantage of limited travel is that the compact nature of the weighing scale 10 is preserved. Referring again to FIG. 1, the overall length 46 of the base 14 may be limited to about twelve inches, and in practice may be as little as ten inches. The overall width 48 of the weighing scale 10 may be limited to about five inches, and in practice may be on the order of four inches. The overall height 50 of the weighing scale 10 in the unloaded condition depicted in FIG. 1 may be limited to about five inches.

As has been mentioned, the analog gauge 22 of the weighing scale 10 may have a display which announces the weight of a load such as the luggage 2. The analog gauge 22 may be modified to convert pressure into units of weight such as pounds or into units of mass such as kilograms in any suitable way. This may be done by selecting the cross sectional area of the analog gauge 22 appropriately, by selecting an appropriate spring rate of a spring which biases the needle 52 of the analog gauge 22 to a zero reading, or by affixing a suitable legend plate to the analog gauge 22.

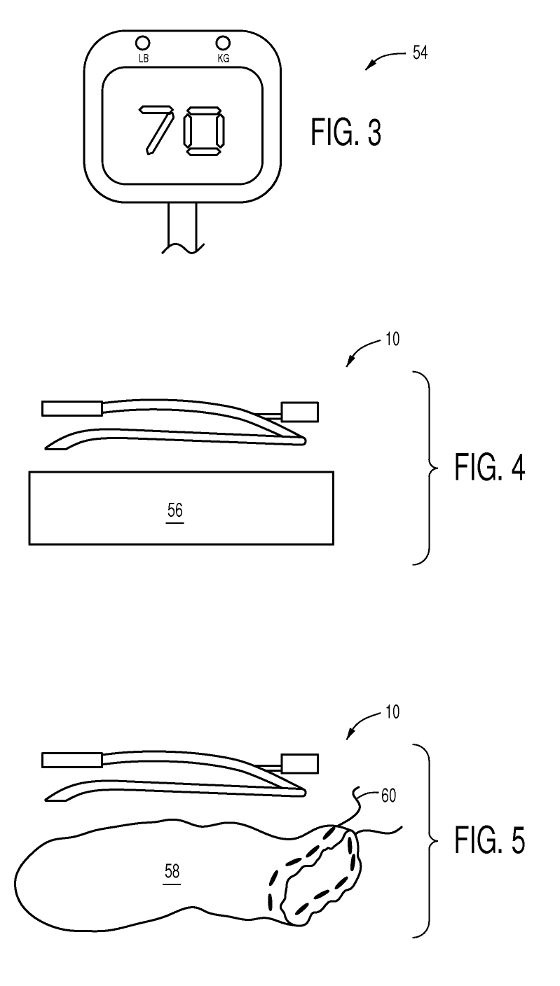

As an alternative to the analog gauge 22, the readout portion or display of the sensor may be electronic. FIG. 3 depicts an electronic gauge 54. The electronic gauge 54 may include selector buttons 56, 58 adapted to control the displayed values of measured weight selectively selectively in English and in metric units of weight. The electronic gauge may also have speaker capabilities and a memory function. The operational functions of the electronic gauge 54 are known and need not be further detailed herein.

A weighing scale such as the weighing scale 10 may be provided commercially in enclosed form, to facilitate the weighing scale being kept as a personal possession. To that end, the weighing scale may be provided with an enclosure which is adapted to receive the weighing scale in close cooperation therein. As seen in FIG. 4, the enclosure may comprise a box such as a corrugated paper carton which is sufficiently rigid as to maintain an outer configuration of a parallelepiped for example. As seen in FIG. 5, the enclosure may comprise a flexible pouch 58 having a drawstring 60 for example.

The present invention is susceptible to variations and modifications which may be introduced thereto without departing from the novel principles. For example, although both the base 14 and the subframe 16 have each been described as comprising four members arranged in rectangular configuration, other constructions are possible. For example, either the base or the subframe 16 could be formed respectively from a cruciform plate (not shown) having its four flanges bent to project at a right angle, or in other ways which would recreate the effect of the described four member configuration. In another example, the spring 42 could be relocated or replaced or supplemented by other spring arrangements (not shown).

A weighing scale according to the present invention may have a weight sensor (not shown) using principles other than pneumatic, such as piezoelectric, spring based, or still others, while still retaining the characteristics of the frame 12 if desired.

A weighing scale according to the present invention may have a feature for adjusting the scale readout, to establish a zero reading in the unloaded condition for example.

A weighing scale according to the present invention may have a weight receiving platform (not shown) adapted for larger objects than as has been illustrated herein, or a weight receiving platform having a feature for adjustability in accommodating loads of various sizes and surface configurations.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A weighing scale comprising:
a structural frame comprising a base disposed to support the weighing scale on a horizontal environmental surface and a subframe coupled to the base;
a weight receiving platform disposed at one end of the structural frame and mounted on the subframe disposed to couple the weight receiving platform to the base;
a sensor disposed to measure weight imposed on the weight receiving platform; and
a display disposed to display measured weight imposed on the weight receiving platform, wherein
the subframe assumes a first location relative to the base when the weighing scale is in an unloaded condition, and the subframe moves pivotally to a second location relative to the base when weight is imposed on the weight receiving platform.

2. The weighing scale of claim 1, wherein the base is configured in at least one view as a rectangle, the subframe is configured in at least one view as a rectangle, one member of the two said rectangles is common to both the base and also to the subframe, and wherein the member of the two said rectangles common to both the base and to the subframe functions as an axle enabling the subframe to move pivotally relative to the base.

3. The weighing scale of claim 1, wherein the sensor operates pneumatically.

4. The weighing scale of claim 3, wherein the sensor comprises a compressible and expansible piston and cylinder assembly.

5. The weighing scale of claim 4, wherein the compressible and expansible piston and cylinder assembly is fixed at one end to the weight receiving platform and also at a point along its length to the subframe.

6. The weighing scale of claim 5, wherein the subframe comprises a first side rail, a second side rail which is spaced apart from and generally parallel to the first side rail, and a laterally disposed member which spans and is coupled to the first side rail and the second side rail, and further wherein the compressible and expansible piston and cylinder assembly is fixed to and supported on the laterally disposed member.

7. The weighing scale of claim 3, wherein the display comprises an analog gauge.

8. The weighing scale of claim 3, wherein the display is electronic.

9. The weighing scale of claim 8, wherein the display comprises a selection feature which displays measured weight selectively in English and in metric units of weight.

10. The weighing scale of claim 1, wherein the length of the base is limited to about twelve inches.

11. The weighing scale of claim 1, wherein the width of the weighing scale is limited to about five inches.

12. The weighing scale of claim 1, wherein the height of the weighing scale in the unloaded condition is limited to about five inches.

13. The weighing scale of claim 1, further comprising an enclosure which is adapted to receive the weighing scale in close cooperation therein.

14. The weighing scale of claim 13, wherein the enclosure comprises a flexible pouch.

15. The weighing scale of claim 13, wherein the enclosure comprises a box which is sufficiently rigid as to maintain an outer configuration of a parallelepiped.

16. The weighing scale of claim 1, further comprising a spring which is disposed to act on the subframe so as to urge the weight receiving platform away from that end of the base which is proximate the weight receiving platform.
